(19) United States
(12) Patent Application Publication
(10) Pub. No.: US 2026/0287762 A1
(43) Pub. Date: Sep. 24, 2026

(54) POSITRON EMISSION TOMOGRAPHY SYSTEMS HAVING DUAL-ENDED READOUT DETECTORS AND METHODS FOR ENHANCING TIMING RESOLUTION

(71) Applicant: The Regents of the University of California, Oakland, CA (US)

(72) Inventors: Junwei Du, Davis, CA (US); Simon Richard Cherry, Davis, CA (US); Haibo Wang, Davis, CA (US); Jinyi Qi, Davis, CA (US)

(21) Appl. No.: 19/084,694

(22) Filed: Mar. 19, 2025

(51) Int. Cl. G01T 1/20; G01T 1/202; G01T 1/29

(52) U.S. Cl. CPC G01T 1/20184; G01T 1/2023; G01T 1/2985

(57) ABSTRACT

Positron emission tomography systems having dual-ended readout detectors and methods for enhancing timing resolution are provided. In some embodiments, a positron emission tomography system is provided that includes: a first dual-ended readout detector and a second dual-ended readout detector, wherein a point source is positioned between the first dual ended readout detector and the second dual-ended readout detector, wherein each of the first dual-ended readout detector and the second dual-ended readout detector comprise: a scintillation crystal, a first photodetector coupled to an end of the scintillation crystal, and a second photodetector coupled to an opposing end of the scintillation crystal, and wherein the first dual-ended readout detector and the second dual-ended readout detector are configured to detect a coincidence event pair resulting from the annihilation of positrons from the point source; and a processor connected to the first dual-ended readout detector and the second dual-ended readout detector, wherein the processor is configured to enhance timing resolution of the positron emission tomography system by: receiving, from the first dual-ended readout detector and the second dual-ended readout detector, timing information corresponding to an arrival time of a photon at each of the first photodetector and the second photodetector and energy signal information indicative of an energy of the photon at each of the first photodetector and the second photodetector; and generating corrected timing information for association with each energy signal received from the first dual-ended readout detector and the second dual-ended readout detector by modifying the timing information based on the energy signal information and a time difference between the timing information from each of the first dual-ended readout detector and the second dual-ended readout detector.

### STATEMENT REGARDING FEDERALLY SPONSORED RESEARCH OR DEVELOPMENT

This invention was made with government support under Grant No. EB028806 awarded by the National Institutes of Health. The government has certain rights in this invention.

### TECHNICAL FIELD

The disclosed subject matter relates to positron emission tomography systems having dual-ended readout detectors and methods for enhancing timing resolution and spatial resolution. More particularly, the disclosure subject matter relates to positron emission tomography systems having dual-ended readout detectors that can provide enhanced timing resolution by generating corrected timing information for association with signals received from the dual-ended readout detectors based on signal information and time difference information, where the corrected timing information can be generated using a time-walk correction method, a timing-shift correction method, or a combination thereof.

### BACKGROUND

Positron emission tomography scanners can produce images that illustrate various biological processes and functions. Typically, in a positron emission tomography scan, a patient is initially injected with a radioactive substance that emits positrons. The injected radioactive substance can act as a tracer when it becomes involved in certain physiological processes in the patient's body. When positrons are emitted from the radioactive substance, the positrons can combine with electrons in the neighboring tissues and become annihilated, where such an annihilation event results in a pair of gamma photons being emitted in opposite directions. The gamma photons can then be detected by a detector unit having a crystal and a photodetector, where the crystal can absorb the energy of the gamma photon and emit the energy as light and where the photodetector attached to the crystal can determine the position and the time of arrival of the photon based on the light emitted by the crystal and can translate such position and timing information into an electrical signal. If the two detector units detect corresponding photon arrivals within a particular time frame, the photons may be determined to be a coincidence event and, therefore, are highly likely to have originated from the same annihilation event.

To accurately determine coincidence events and thereby obtain useful information for generating an image, the positron emission tomography imaging system can use timing circuits to accurately identify and log the times at which photons are received at the photodetectors. The timing circuits typically include digital counters that count time periods based upon a digital clock and digital counter latches that receive both the count signals from the counters and energy signals from the photodetector whenever photons are detected. Based upon the count signals, the counter latches effectively timestamp the energy signals with times indicative of when the energy signals are received, and output this information for use by the positron emission tomography imaging system in determining coincidence events.

The positron emission tomography imaging system can be used to acquire time-of-flight (TOF) data for the coincidence events by determining the difference between the timestamps of the two coincidence gamma photons. The positron emission tomography imaging system can use this determined difference to estimate the location along the line joining the two photodetectors where the positron-electron annihilation occurred.

In operation, the timing circuits of the positron emission tomography imaging system can use a leading edge discriminator on an analog signal output from the photodetector to identify the time at which a photon was received at the photodetector. A leading edge discriminator produces a logic signal when the analog signal from the photodetector crosses a predetermined threshold level (Vₜₕ). However, the time at which the analog signal crosses the predetermined threshold level and, therefore, the time when the leading edge discriminator produces the logic signal depends on the amplitude of the analog signal. Multiple factors, however, may vary the amplitude of the analog signal. As a result, changes in the height of the analog signal may occur causing the logic signal to walk along the time axis (which is sometimes referred to as “time-walk”).

In addition, due to the thickness of the crystal used in positron emission tomography imaging system, the interaction position of the gamma photon in the crystal deteriorates coincidence timing resolution as the interaction position of the gamma photon affects the time it takes for the scintillation light to reach the photodetector, which contribute to timing-shift. Timing-shift can reduce timing resolution, thereby resulting in a potential distortion in image quality.

Accordingly, it is desirable to provide methods, systems, and media that overcome these and other deficiencies in the prior art. For example, positron emission tomography systems having dual-ended readout detectors and methods for enhancing timing resolution are provided.

### SUMMARY

Positron emission tomography systems having dual-ended readout detectors and methods for enhancing timing resolution are provided.

In accordance with some embodiments of the disclosed subject matter, a positron emission tomography system is provided that includes: a first dual-ended readout detector and a second dual-ended readout detector, where a point source is positioned between the first dual ended readout detector and the second dual-ended readout detector, where each of the first dual-ended readout detector and the second dual-ended readout detector comprise: a scintillation crystal, a first photodetector coupled to an end of the scintillation crystal, and a second photodetector coupled to an opposing end of the scintillation crystal, and where the first dual-ended readout detector and the second dual-ended readout detector are configured to detect a coincidence event pair resulting from the annihilation of positrons from the point source; and a processor connected to the first dual-ended readout detector and the second dual-ended readout detector, where the processor is configured to enhance timing resolution of the positron emission tomography system by: receiving, from the first dual-ended readout detector and the second dual-ended readout detector, timing information corresponding to an arrival time of a photon at each of the first photodetector and the second photodetector and energy signal information indicative of an energy of the photon at each of the first photodetector and the second photodetector; and generating corrected timing information for association with each energy signal received from the first dual-ended readout detector and the second dual-ended readout detector by modifying the timing information based on the energy signal information and a time difference between the timing information from each of the first dual-ended readout detector and the second dual-ended readout detector.

In some embodiments, the scintillation crystal in each of the first dual-ended readout detector and the second dual-ended readout detector is a scintillation crystal array having a plurality of scintillation crystal elements. In some embodiments, each of the plurality of scintillation crystal elements in the scintillation crystal array is composed of one of: a lutetium-yttrium oxyorthosilicate (LYSO) crystal element, a bismuth germanate (BGO) crystal element, a gadolinium aluminum gallium garnet (GAGG) crystal element, and a lutetium oxyorthosilicate (LSO) crystal element.

In some embodiments, the scintillation crystal array includes an inter-crystal reflector. In some embodiments, the inter-crystal reflector in the scintillation crystal array is composed of barium sulfate.

In some embodiments, each of the first photodetector and the second photodetector is a photodetector array having a plurality of photodetector elements.

In some embodiments, each of the plurality of photodetector elements in the photodetector array corresponds to a scintillation crystal element in the scintillation crystal array.

In some embodiments, a coupling material is placed between the scintillation crystal and each of the first photodetector and the second photodetector.

In some embodiments, each of the plurality of photodetector elements in the photodetector array is a silicon photomultiplier.

In some embodiments, the processor is further configured to determine the timing information for each of the first dual-ended readout detector and the second dual-ended readout detector based on first timing information received by the first photodetector and second timing information received by the second photodetector.

In some embodiments, the processor is further configured to determine the timing information for each of the first dual-ended readout detector and the second dual-ended readout detector by averaging first timing information received by the first photodetector and second timing information received by the second photodetector.

In some embodiments, the processor is connected to a first acquisition circuit and a second acquisition circuit, where the first acquisition circuit is configured to obtain the timing information and the energy signal from the first photodetector and the second photodetector of the first dual-ended readout detector, and where the second acquisition circuit is configured to obtain the timing information and the energy signal from the first photodetector and the second photodetector of the second dual-ended readout detector.

In some embodiments, the processor is further configured to divide the scintillation crystal in the first dual-ended readout detector and the second dual-ended readout detector into a plurality of depth-of-interaction layers, where the timing information and the energy signal information is associated with one of the plurality of depth-of-interaction layers based on a ratio of a first signal amplitude of the energy signal information detected by the first photodetector and a second signal amplitude of the energy signal information detected by the second photodetector, and where timing resolution including the corrected timing information is determined for pairs of the plurality of depth-of-interaction layers in the first dual-ended readout detector and the second dual-ended readout detector.

In some embodiments, the processor is further configured to modify the timing information in each of the plurality of depth-of-interaction layers based on a logarithmic relationship between the ratio of the first signal amplitude of the energy signal information detected by the first photodetector and the second signal amplitude of the energy signal information detected by the second photodetector and timing difference information based on first timing information corresponding to the arrival time of the photon at the first photodetector and second timing information corresponding to the arrival time of the photon at the second photodetector.

In accordance with some embodiments of the disclosed subject matter, a method for generating enhanced images using a positron emission tomography system is provided, the method comprising: receiving, from a processor connected to a first dual-ended readout detector and a second dual-ended readout detector, where a point source is positioned between the first dual ended readout detector and the second dual-ended readout detector, where each of the first dual-ended readout detector and the second dual-ended readout detector comprise: a scintillation crystal, a first photodetector coupled to an end of the scintillation crystal, and a second photodetector coupled to an opposing end of the scintillation crystal, and where the first dual-ended readout detector and the second dual-ended readout detector are configured to detect a coincidence event pair resulting from the annihilation of positrons from the point source, timing information corresponding to an arrival time of a photon at each of the first photodetector and the second photodetector and energy signal information indicative of an energy of the photon at each of the first photodetector and the second photodetector; generating corrected timing information for association with each energy signal received from the first dual-ended readout detector and the second dual-ended readout detector by modifying the timing information based on the energy signal information and a time difference between the timing information from each of the first dual-ended readout detector and the second dual-ended readout detector; and generating an image of an object using the corrected timing information.

In some embodiments, the method further comprises determining the timing information for each of the first dual-ended readout detector and the second dual-ended readout detector based on first timing information received by the first photodetector and second timing information received by the second photodetector.

In some embodiments, the method further comprises determining the timing information for each of the first dual-ended readout detector and the second dual-ended readout detector by averaging first timing information received by the first photodetector and second timing information received by the second photodetector.

In some embodiments, the method further comprises using a first acquisition circuit to obtain the timing information and the energy signal from the first photodetector and the second photodetector of the first dual-ended readout detector and using a second acquisition circuit to obtain the timing information and the energy signal from the first photodetector and the second photodetector of the second dual-ended readout detector.

In some embodiments, the method further comprises dividing the scintillation crystal in the first dual-ended readout detector and the second dual-ended readout detector into a plurality of depth-of-interaction layers, where the timing information and the energy signal information is associated with one of the plurality of depth-of-interaction layers based on a ratio of a first signal amplitude of the energy signal information detected by the first photodetector and a second signal amplitude of the energy signal information detected by the second photodetector, and where timing resolution including the corrected timing information is determined for pairs of the plurality of depth-of-interaction layers in the first dual-ended readout detector and the second dual-ended readout detector.

In some embodiments, the method further comprises modifying the timing information in each of the plurality of depth-of-interaction layers based on a logarithmic relationship between the ratio of the first signal amplitude of the energy signal information detected by the first photodetector and the second signal amplitude of the energy signal information detected by the second photodetector and timing difference information based on first timing information corresponding to the arrival time of the photon at the first photodetector and second timing information corresponding to the arrival time of the photon at the second photodetector.

In accordance with some embodiments of the disclosed subject matter, a non-transitory computer-readable medium containing computer executable instructions that, when executed by a processor, cause the processor to perform a method for generating enhanced images using a positron emission tomography system is provided, the method comprising: receiving, from a processor connected to a first dual-ended readout detector and a second dual-ended readout detector, wherein a point source is positioned between the first dual ended readout detector and the second dual-ended readout detector, wherein each of the first dual-ended readout detector and the second dual-ended readout detector comprise: a scintillation crystal, a first photodetector coupled to an end of the scintillation crystal, and a second photodetector coupled to an opposing end of the scintillation crystal, and wherein the first dual-ended readout detector and the second dual-ended readout detector are configured to detect a coincidence event pair resulting from the annihilation of positrons from the point source, timing information corresponding to an arrival time of a photon at each of the first photodetector and the second photodetector and energy signal information indicative of an energy of the photon at each of the first photodetector and the second photodetector; generating corrected timing information for association with each energy signal received from the first dual-ended readout detector and the second dual-ended readout detector by modifying the timing information based on the energy signal information and a time difference between the timing information from each of the first dual-ended readout detector and the second dual-ended readout detector; and generating an image of an object using the corrected timing information.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows a schematic diagram of a time-of-flight (TOF) depth of interaction (DOI) detector assembly for a positron emission tomography (PET) system in accordance with some embodiments of the disclosed subject matter.

FIG. 2 is a block diagram of hardware that can be used in a computing device of FIG. 1 in accordance with some embodiments of the disclosed subject matter.

FIG. 3 shows an illustrative example of a process for generating corrected timing information in a positron emission tomography system having a detector assembly that includes a pair of time-of-flight dual-ended readout detectors in accordance with some embodiments of the disclosed subject matter.

FIG. 4 shows illustrative representations of timing information and energy information based on an interaction location within a scintillator crystal for a pair of time-of-flight dual-ended readout detectors in accordance with some embodiments of the disclosed subject matter.

FIG. 5 shows illustrative representations of uncorrected timing signals, corrected timing signals, and a combined signal including the correct timing signal with coincidence events following the application of an energy window in accordance with some embodiments of the disclosed subject matter.

FIG. 6 shows an illustrative example of a process for determining the number of depth-of-interaction layers in a scintillator crystal for a pair of time-of-flight dual-ended readout detectors in accordance with some embodiments of the disclosed subject matter.

FIG. 7 shows an illustrative example of timing resolution across crystal pairs based on the number of depth-of-interaction layers in accordance with some embodiments of the disclosed subject matter.

FIG. 8 shows illustrative scatter plots of uncorrected timing difference versus the logarithm of energy ratio for each depth-of-interaction layer pair in accordance with some embodiments of the disclosed subject matter.

FIG. 9 shows illustrative tables of fitting information determined from the scatter plot of FIG. 8 for generating time-walk time correction information and timing-shift time correction information in accordance with some embodiments of the disclosed subject matter.

FIG. 10 shows illustrative scatter plots of corrected timing difference versus the logarithm of energy ratio for each depth-of-interaction layer pair in accordance with some embodiments of the disclosed subject matter.

FIG. 11 shows an illustrative example of uncorrected timing signals for multiple depth-of-interaction layers, corrected timing signals for multiple depth-of-interaction layers, and combined signals with coincidence events following the application of an energy window in accordance with some embodiments of the disclosed subject matter.

FIG. 12 shows illustrative examples of coincidence timing resolution of selected crystal pairs from the two dual-ended readout detector blocks in coincidence using uncorrected timing information and corrected timing information in accordance with some embodiments of the disclosed subject matter.

### DETAILED DESCRIPTION

In accordance with some embodiments of the disclosed subject matter, positron emission tomography systems having dual-ended readout detectors and methods for enhancing timing resolution are provided. More particularly, positron emission tomography systems having dual-ended readout detectors can provide enhanced timing resolution by generating corrected timing information for association with signals received from the dual-ended readout detectors based on signal information and time difference information, where the corrected timing information can be generated using a time-walk correction method, a timing-shift correction method, or a combination thereof.

Generally speaking, the time-walk correction method and the timing-shift correction method can be used to correct timing information obtained from a positron emission tomography system having two dual-ended readout detectors in coincidence, where the time-walk correction method and the timing-shift correction method generate modified timing information based on the energy signal information and a time difference between the timing information from each dual-ended readout detector in the pair of dual-ended readout detectors. For example, the modified timing information can be determined using a logarithmic relationship between the energy signal information (e.g., a ratio of signal amplitudes of the energy signals obtained from each readout detector in a dual-ended readout detector) and based on timing information (e.g., a time difference when a photon was detected by each readout detector in a dual-ended readout detector) in one or more depth-of-interaction layers.

It should be noted that, although the disclosed subject matter has been described and illustrated herein in connection with positron emission tomography systems, this is merely illustrative and the time-walk correction method, the timing-shift correction method, and other features for enhancing timing resolution can be used with any suitable instrumentation, implementation, or equipment having dual-ended readout detectors in coincidence to detect events.

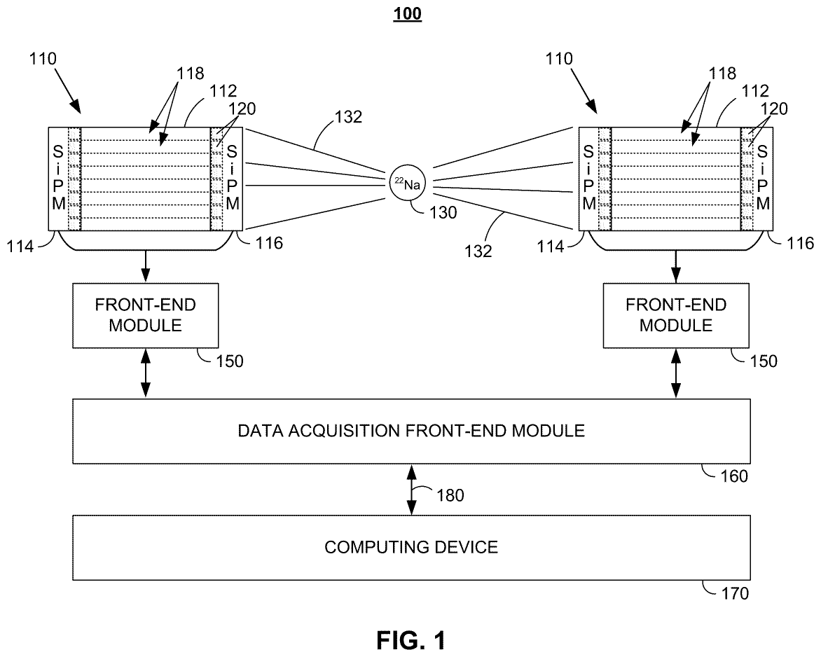

These and other features for providing positron emission tomography systems having dual-ended readout detectors and methods for enhancing timing resolution are further described in connection with FIGS. 1-12.

Turning to FIG. 1, a schematic diagram of a time-of-flight (TOF) depth of interaction (DOI) detector assembly 100 for a positron emission tomography (PET) system is shown in accordance with some embodiments of the disclosed subject matter.

As shown in FIG. 1, detector assembly 100 can include at least two time-of-flight dual-ended readout detector blocks 110 (which can each include a scintillator array 112 coupled between a first photodetector array 114 and a second photodetector array 116), where the two time-of-flight dual-ended readout detector blocks 110 can be positioned on opposing ends of a point source 130 to detect coincident event photons. In a more particular example, point source 130 can be a ²²Na point source for irradiating detector assembly 100, where point source 130 can be centrally located between two dual-ended readout detector blocks 110 of detector assembly 100 such that positrons from point source 130 can annihilate with electrons to emit gamma photons in opposite directions and where the gamma photons can be detected by a pair of time-of-flight dual-ended readout detector blocks 110.

It should be noted that, although detector assembly 100 shown in FIG. 1 includes a pair of time-of-flight dual-ended readout detector blocks 110 that detect coincident event photons, this is merely illustrative and the positron emission tomography system can include any suitable number of pairs of time-of-flight dual-ended readout detector blocks 110. For example, the positron emission tomography system can have a cylindrical detector ring assembly that is composed of adjacent dual-ended readout detector blocks 110 that form a complete ring for generating an image of an object.

In some embodiments, each dual-ended readout detector block 110 of detector assembly 100 can include first photodetector array 114 and second photodetector array 116 that are positioned on opposing ends of scintillator array 112. For example, as shown in FIG. 1, first photodetector array 114 can be coupled to one end of scintillator array 112 using a coupling material, such as an optical grease, and second photodetector array 114 can be coupled to the opposing end of scintillator array 112 using the coupling material.

In some embodiments, scintillator array 112 can include any suitable number of scintillator crystal elements or scintillator material 118 that convert gamma rays (e.g., ionization radiation 132) into visible light (e.g., photons). It should be noted that scintillator array 112 can include one or more lutetium-yttrium oxyorthosilicate (LYSO) crystal elements, one or more bismuth germanate (BGO) crystal elements, one or more gadolinium aluminum gallium garnet (GAGG) crystal elements, one or more lutetium oxyorthosilicate (LSO) crystal elements, one or more sodium iodide (NaI) crystal elements, one or more alkali halide crystal elements, one or more cesium iodide (CsI) crystal elements, or any other suitable crystal element. It should be noted that, although FIG. 1 shows eight scintillator crystal elements 118 (e.g., in an 8×8 array), this is merely illustrative and scintillator array 112 can be composed of any suitable number of scintillator crystal elements 118.

In some embodiments, a reflector material can be positioned between scintillator crystal elements or scintillator material 118. For example, in some embodiments, barium sulfate (BaSO₄) with a thickness of about 100 microns can be used as an inter-crystal reflector in scintillator array 112 that is composed of lutetium-yttrium oxyorthosilicate crystal elements. Such a reflector material can, for example, ensure optical isolation within each of the scintillator crystal elements.

In some embodiments, first photodetector array 114 and second photodetector array 116 that are positioned on opposing ends of scintillator array 112 can be any suitable light sensor that converts light (e.g., photons) into an electrical signal, where the electrical signals can be used to reconstruct a tomographic image. For example, as shown in FIG. 1, first photodetector array 114 and second photodetector array 116 can include one or more silicon photomultipliers (SiPMs) 120. Alternatively, in some embodiments, first photodetector array 114 and second photodetector array 116 can include one or more photomultiplier tubes (PMTs), avalanche photodiodes (APDs), or any other suitable light sensing device. It should be noted that, although FIG. 1 shows eight pairs of silicon photomultipliers 120 in first photodetector array 114 and second photodetector array 116 that correspond with eight scintillator crystal elements 118 (e.g., where each photodetector array 114 and 116 is formed in an 8×8 array), there is merely illustrative and first photodetector array 114 and second photodetector array 116 can include any suitable number of photomultipliers 120.

As shown in FIG. 1, each scintillator array 112 can be an 8×8 array of lutetium-yttrium oxyorthosilicate crystal elements and each of first photodetector array 114 and second photodetector array 116 can be a complementary 8×8 array of silicon photomultipliers such that each lutetium-yttrium oxyorthosilicate crystal element in scintillator array 112 can be aligned between a first silicon photomultiplier in first photodetector array 114 that is positioned on one end of the lutetium-yttrium oxyorthosilicate crystal element and a second silicon photomultiplier in second photodetector array 116 that is positioned on an opposing end of the lutetium-yttrium oxyorthosilicate crystal element. In a more particular example, each scintillator array 112 can be an 8×8 array of 3.1×3.1×20 mm³ lutetium-yttrium oxyorthosilicate crystal elements with a 3.2 millimeter pitch and each of first photodetector array 114 and second photodetector array 116 can be a complementary 8×8 array of silicon photomultipliers also having a 3.2 mm pitch across the silicon photomultiplier arrays such that each lutetium-yttrium oxyorthosilicate crystal element in scintillator array 112 can be aligned between a first silicon photomultiplier in first photodetector array 114 that is positioned on one end of the lutetium-yttrium oxyorthosilicate crystal element and a second silicon photomultiplier in second photodetector array 116 that is positioned on an opposing end of the lutetium-yttrium oxyorthosilicate crystal element.

It should be noted that, although FIG. 1 shows an illustrative example in which each scintillator array 112 can be an 8×8 array of lutetium-yttrium oxyorthosilicate crystal elements and each of first photodetector array 114 and second photodetector array 116 on opposing ends of scintillator array 114 can be a complementary 8×8 array of silicon photomultipliers, this is merely illustrative. Scintillator array 112 can include any suitable number of crystal elements (e.g., one crystal element, two crystal elements, a 2×2 array of crystal elements, etc.) and each of first photodetector array 114 and second photodetector array 116 on opposing ends of scintillator array 112 can include any suitable number of photodetectors (e.g., one photodetectors, two photodetectors, a 2×2 array of photodetectors, etc.).

It should also be noted that, although FIG. 1 shows an illustrative example in which each lutetium-yttrium oxyorthosilicate crystal element in scintillator array 112 can be aligned between a first silicon photomultiplier in first photodetector array 114 that is positioned on one end of the lutetium-yttrium oxyorthosilicate crystal element and a second silicon photomultiplier in second photodetector array 116 that is positioned on an opposing end of the lutetium-yttrium oxyorthosilicate crystal element, this is merely illustrative. For example, four lutetium-yttrium oxyorthosilicate crystal elements in scintillator array 112 (e.g., in a 2×2 portion of scintillator array 112, in a 4×1 portion of scintillator array 112, etc.) can be aligned between a first silicon photomultiplier in a first photodetector array 114 that is positioned on one end of the four lutetium-yttrium oxyorthosilicate crystal elements and a second silicon photomultiplier in a second photodetector array 114 that is positioned on an opposing end of the four lutetium-yttrium oxyorthosilicate crystal elements.

In some embodiments, signal data from first photodetector arrays 114 and second photodetector arrays 116 in dual-ended readout detector blocks 110 of detector assembly 100 can be obtained using any suitable data acquisition circuitry. For example, each first photodetector arrays 114 and second photodetector arrays 116 in a pair of dual-ended readout detector blocks 110 of detector assembly 100 can, as described hereinbelow, determine a time or a timing signal that represents an arrival time of a photon at a photodetector. In another example, each first photodetector arrays 114 and second photodetector arrays 116 in a pair of dual-ended readout detector blocks 110 of detector assembly 100 can, as described hereinbelow, determine an energy signal indicative of the energy of the gamma ray received at a photodetector. In a more particular example, a positron emission tomography system that includes a detector assembly 100 having a pair of time-of-flight dual-ended readout detector blocks 110 can generate multiple analog signals that are used to reconstruct an image of an object being scanned. The analog signals can then be used to determine whether two gamma rays are in coincidence and detected by the pair of time-of-flight dual-ended readout detector blocks 110. To identify a coincidence event, the leading edge of the analog signals can be identified and timestamped. One or more timing corrections can be made to modify the timestamp or the timing signal used to reconstruct an image of an object being scanned.

For example, as shown in FIG. 1, the data acquisition circuitry can be a PETsys TOFPET2 readout system that includes two front-end modules 150 connected to detector assembly 100, where each first photodetector array 114 and second photodetector array 116 in dual-ended readout detector block 110 of detector assembly 100 can be mounted or otherwise connected to a front-end module 150. In continuing the above-mentioned example in which 128 photomultiplier signals are output, the outputs of each first photodetector array 114 and second photodetector array 116 in dual-ended readout detector block 110 of detector assembly 100 can be processed by front-end module 150, such as a FEM128 board that includes TOFPET2 application specific integrated circuits (ASICs) reading 128 channels. As such, the 128 channels in each front-end module 150 can individually process the 128 signals from first photodetector array 114 and second photodetector array 116 in each of dual-ended readout detector blocks 110 of detector assembly 100, which can include energy signals and timing information.

In some embodiments, the data acquisition circuitry (e.g., the PETsys TOFPET2 readout system) can also include one or more additional data acquisition front-end modules 160, such as a Front End Board Type D (FEB/D) readout board in which each of the signals received and processed by front-end modules 150 can be further transmitted to data acquisition front-end module 160 for further data processing. For example, each front-end module 150 can route the outputs, which can include energy signals and timing information from the photodetector arrays, to data acquisition front-end module 160 for further data processing. In a more particular example, energy signals from one dual-ended readout detector block 110 can be associated with corresponding energy signals from the opposing dual-ended readout detector block 110 in a pair of photodetectors. In another example, front-end module 160 can provide the bias voltage for the photodetector arrays (e.g., first photodetector array 114 and second photodetector array 116 in each of dual-ended readout detector blocks 110 of detector assembly 100) or any other suitable configuration information.

In some embodiments, data acquisition front-end modules 160 can be connected to a computing device 170. For example, a PETsys Front End Board Type D (FEB/D) readout board 160 that is connected to two front-end modules 150 can also be connected to computing device 170 by one or more communications links (e.g., communications links 180). The communications links 180 can, in some embodiments, be any communications links suitable for communicating data among computing device 170 and user devices 616 and data acquisition front-end modules 160 or any other suitable component of the data acquisition circuitry, such as network links, dial-up links, wireless links, hard-wired links, any other suitable communications links, or any suitable combination of such links.

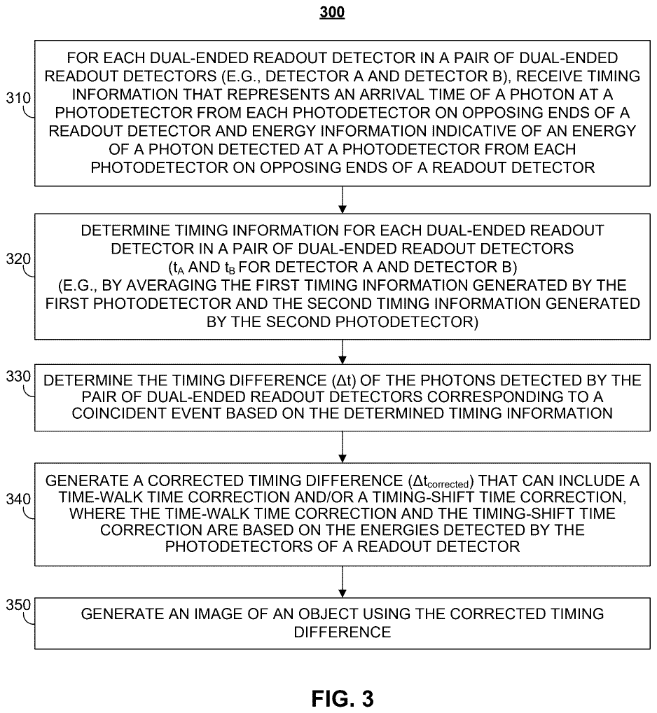

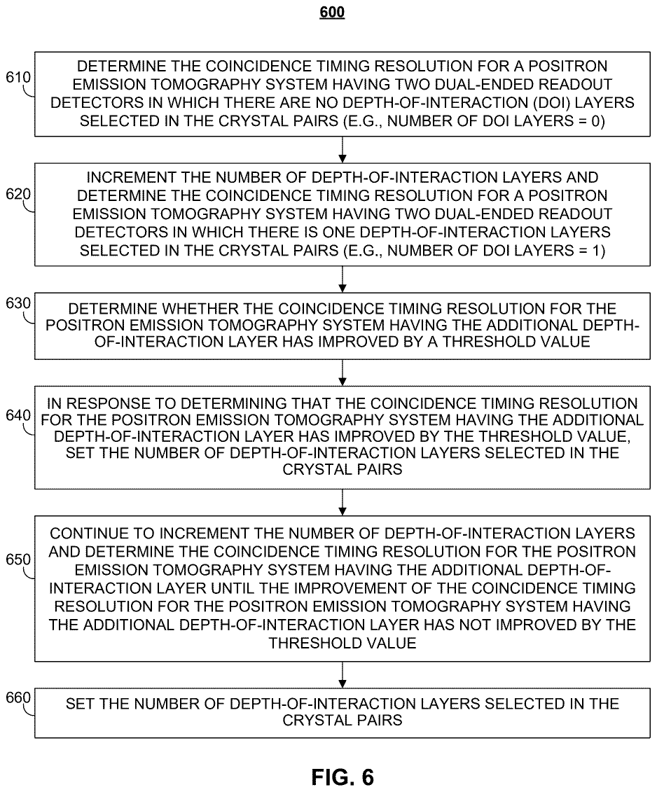

Computing device 170 can include any one or more user devices suitable for determining timing information and energy information from the positron emission tomography system, for categorizing detected events and corresponding event information into one of multiple depth-of-interaction layers, and for generating updated timing information that corrects for time-walk and/or timing-shift based on the determined energy information, timing information, and/or depth-of-interaction information from a positron emission tomography system having two time-of-flight dual-ended readout detector blocks. For example, in some embodiments, computing device 170 can execute any of the blocks of processes 300 and 600 as shown in and described below in connection with FIGS. 3 and 6. As another example, in some embodiments, computing device 170 can transmit instructions to another computing device to perform any of the functions described below in connection with FIGS. 3 and 6.

In some embodiments, computing device 170 can include any suitable types of devices. For example, in some embodiments, computing device 170 can include a desktop computer, a laptop computer, a mobile phone, a tablet computer, and/or any other suitable type of user device. As another example, in some embodiments, computing device 170 can be an ASIC, Field Programmable Gate Arrays (FPGAs), or any other dedicated computing device.

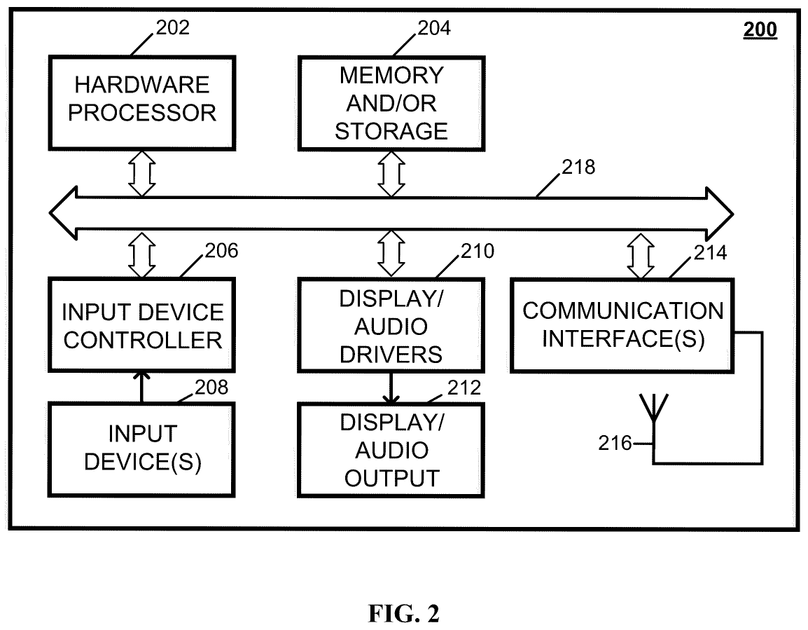

In some embodiments, computing device 170 can be implemented using any suitable hardware. For example, in some embodiments, computing device 170 can be implemented using any suitable general-purpose computer or special-purpose computer. For example, a mobile phone may be implemented using a special-purpose computer. Any such general-purpose computer or special-purpose computer can include any suitable hardware. For example, as illustrated in example hardware 200 of FIG. 2, such hardware can include hardware processor 202, memory and/or storage 204, an input device controller 206, an input device 208, display/audio drivers 210, display and audio output circuitry 212, communication interface(s) 214, an antenna 216, and a bus 218.

Hardware processor 202 can include any suitable hardware processor, such as a microprocessor, a micro-controller, digital signal processor(s), dedicated logic, and/or any other suitable circuitry for controlling the functioning of a general-purpose computer or a special-purpose computer in some embodiments. In some embodiments, hardware processor 202 can be controlled by a server program stored in memory and/or storage of a server, such as server 202. In some embodiments, hardware processor 202 can be controlled by a computer program stored in memory and/or storage 204 of computing device 170.

Memory and/or storage 204 can be any suitable memory and/or storage for storing programs, data, and/or any other suitable information in some embodiments. For example, memory and/or storage 204 can include random access memory, read-only memory, flash memory, hard disk storage, optical media, and/or any other suitable memory.

Input device controller 206 can be any suitable circuitry for controlling and receiving input from one or more input devices 208 in some embodiments. For example, input device controller 206 can be circuitry for receiving input from a touchscreen, from a keyboard, from one or more buttons, from a voice recognition circuit, from a microphone, from a camera, from an optical sensor, from an accelerometer, from a temperature sensor, from a near field sensor, from a pressure sensor, from an encoder, and/or any other type of input device.

Display/audio drivers 210 can be any suitable circuitry for controlling and driving output to one or more display/audio output devices 212 in some embodiments. For example, display/audio drivers 210 can be circuitry for driving a touchscreen, a flat-panel display, a cathode ray tube display, a projector, a speaker or speakers, and/or any other suitable display and/or presentation devices.

Communication interface(s) 214 can be any suitable circuitry for interfacing with one or more communication networks (e.g., computer network 404). For example, interface(s) 514 can include network interface card circuitry, wireless communication circuitry, and/or any other suitable type of communication network circuitry.

Antenna 216 can be any suitable one or more antennas for wirelessly communicating with a communication network in some embodiments. In some embodiments, antenna 216 can be omitted.

Bus 218 can be any suitable mechanism for communicating between two or more components 202, 204, 206, 210, and 214 in some embodiments.

Any other suitable components can be included in hardware 200 in accordance with some embodiments.

In some embodiments, the positron emission tomography system having detector assembly 100 that includes a pair of time-of-flight dual-ended readout detector blocks 110 can be used to obtain timing information and energy information from the photodetectors in the pair of time-of-flight dual-ended readout detector blocks 110 and can correct the timing information to account for time-walk and/or timing-shift.

Turning to FIG. 3, an illustrative example of a process 300 for generating corrected timing information in a positron emission tomography system having a detector assembly that includes a pair of time-of-flight dual-ended readout detectors is shown in accordance with some embodiments of the disclosed subject matter. In some embodiments, blocks of process 300 can be performed on any suitable device, such as computing device 170, a server, or any other suitable device. In some embodiments, blocks of process 300 can be performed using multiple devices.

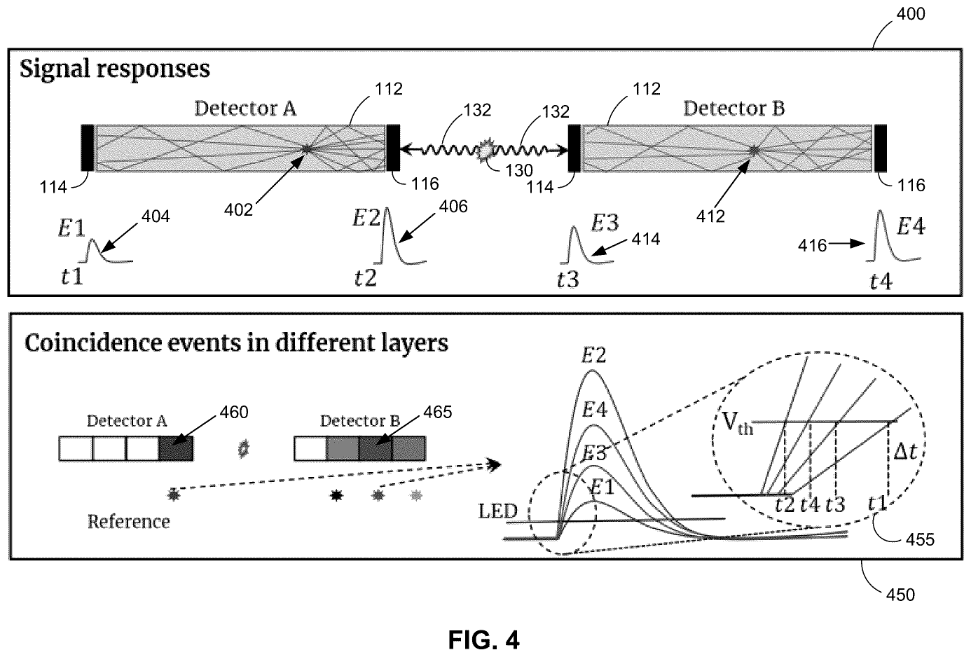

In using detector assembly 100 that includes time-of-flight dual-ended readout detector blocks 110 for time-of-flight positron emission tomography, as shown in a representation 400 of FIG. 4, two gamma photons can be emitted in opposite directions when a positron annihilates with an electron (which is sometimes referred to as an “annihilation event” or a “coincidence event”). The line connecting the two gamma photons that are emitted in opposite directions during a coincidence event is sometimes referred to as a “line of response.”

It should be noted that the signal-to-noise ratio of the reconstructed images can be enhanced by estimating the interaction position of the gamma photon along the line-of-response. The time-of-flight gain factor for the signal-to-noise ratio of the reconstructed image can be represented by:

$$\sqrt{\frac{2 L}{c {δ}_{t}}}$$

where L is the size of the object, c is the speed of light, and δₜ is the coincidence timing resolution of the time-of-flight positron emission tomography system. This is generally equivalent to a gain factor of

$$\frac{2 L}{c {δ}_{t}}$$

for the sensitivity of the time-of-flight positron emission tomography system.

It should also be noted that, in embodiments such as the one shown in FIG. 1 in which detector assembly 100 includes time-of-flight dual-ended readout detector blocks 110, scintillator array 112 can include lutetium-yttrium oxyorthosilicate crystal elements or lutetium oxyorthosilicate (LSO) crystal elements having a thickness of about 20 millimeters, the interaction position of the gamma photon along the radial direction of the crystal elements (which is sometimes referred to as “depth-of-interaction” or “DOI”) can deteriorate the coincidence timing resolution of the time-of-flight positron emission tomography system as depth-of-interaction can affect the time of scintillation light reaching each of the photodetectors. This depth-of-interaction effect can contribute to timing-shift. Note that multiple different factors can contribute to timing-shift, such as the travel time of the gamma photon in the crystal (which relates to the depth-of-interaction), the travel time of the scintillation photon from the interaction position to the photodetector (which also relates to the depth-of-interaction), and the readout or data acquisition circuitry described above (e.g., the different lengths of the signal traces). Thus, the techniques described herein to determine depth-of-interaction information or the interaction position of the gamma photon can be used to correct timing-shift, thereby enhancing image quality of the time-of-flight positron emission tomography system.

In some instances, in ring geometry positron emission tomography systems having a source (e.g., point source 130) at the center of the field-of-view, emitted photons can enter the photodetectors perpendicularly to the detector face. When the source location has a radial offset from the center, however, the photodetectors can become angled with respect to the line-of-response and the annihilation photons may penetrate through a first encountered photodetector while being detected by an adjacent photodetector. As a consequence, the radial spatial resolution in the radial and axial directions degrades toward the peripheral field-of-view. This is sometimes referred to as the parallax effect or parallax error. Thus, the techniques described herein to determine depth-of-interaction information or the interaction position of the gamma photon can be used to reduce the parallax effect, thereby enhancing image quality of the time-of-flight positron emission tomography system.

Additionally to determining depth-of-interaction information, the approach for timing pick-off can affect the coincidence timing resolution of the time-of-flight positron emission tomography system.

In some embodiments, a leading-edge timing pick-off technique can be used to extract timing information from detector assembly 100. It should be noted, however, that the leading-edge timing pick-off technique may be susceptible to talk-walk due to the finite rise time of the signal. Time-walk may be influenced by the signal amplitude of the energy signal and, as described herein, can be corrected by leveraging the relationship between the threshold crossing time (that is, the time to cross a pre-set threshold, Vₜₕ) and the signal amplitude or event energy of the energy signal on an event-by-event basis. Such a time-walk correction to the extracted timing information can, for example, improve timing resolution of a positron emission tomography detector that includes detector assembly 100.

It should be noted that, in embodiments such as the one shown in FIG. 1 in which detector assembly 100 includes time-of-flight dual-ended readout detector blocks 110, a portion of the scintillation photons emitted by a scintillator material, such as scintillator array 112, may be lost before reaching first photodetector array 114 or second photodetector array 116 that are coupled to scintillator array 112. This can be, for example, due to absorption by the crystal in scintillator array 112, due to absorption by a reflector material (such as an inter-crystal reflector composed of barium sulfate in scintillator array 112), and/or due to escape from the lateral surfaces of the crystal in scintillator array 112. The ratio of lost scintillation photons is generally related to the interaction location of the gamma photon. That is, when a crystal in scintillator array 112 detects a gamma photon, the arrival timing of the scintillation photons at first photodetector array 114 or second photodetector array 116 coupled to each end of scintillator array 112 and the signals detected by first photodetector array 114 and second photodetector array 116 can vary with the interaction location of the gamma photon or the depth-of-interaction (sometimes referred to as “DOI”).

Generally speaking, the photodetector closer to the interaction location of the gamma photon (e.g., first photodetector array 114 or second photodetector array 116) generates a larger energy signal than the energy signal generated by the other photodetector and detects the gamma photon earlier than the other photodetector. For example, as shown in a representation 400 of FIG. 4, a gamma photon 402 is detected within scintillator array 112 of detector A, which is one of the pair of time-of-flight dual-ended readout detector blocks 110 in detector assembly 100. As also shown in representation 400 of FIG. 4, the interaction location of the gamma photon 402 is closer to second photodetector array 116 between first photodetector array 114 and second photodetector array 116 positioned on opposing ends of scintillator array 112. Based on the interaction location of the gamma photon 402 being closer to second photodetector array 116 than first photodetector array 114, second photodetector array 116 can receive more scintillation photons and can generate a larger energy signal 406 (represented by E2 in representations 400 and 450) than the energy signal 404 generated by first photodetector array 116 (represented by E1 in representations 400 and 450). In addition, because the larger energy signal 406 crosses a threshold value (Vₜₕ) earlier than energy signal 404, second photodetector array 116 generates a timestamp or any other suitable timing information (represented by t2 in an enlarged portion 455 of representation 450) that is earlier than the timestamp or any other suitable timing information generated by first photodetector array 114 (represented by t1 in enlarged portion 455 of representation 450).

In continuing this example, as shown in representation 400 of FIG. 4, a gamma photon 412 is detected within scintillator array 112 of detector B, which is one of the pair of time-of-flight dual-ended readout detector blocks 110 in detector assembly 100. As also shown in representation 400 of FIG. 4, the interaction location of the gamma photon 412 is closer to second photodetector array 116 between first photodetector array 114 and second photodetector array 116 positioned on opposing ends of scintillator array 112. Again, based on the interaction location of the gamma photon 412 being closer to second photodetector array 116 than first photodetector array 114, second photodetector array 116 can receive more scintillation photons and can generate a larger energy signal 416 (represented by E4 in representations 400 and 450) than the energy signal 414 generated by first photodetector array 116 (represented by E3 in representations 400 and 450). In addition, because the larger energy signal 416 crosses a threshold value (Vₜₕ) earlier than energy signal 414, second photodetector array 116 generates a timestamp or any other suitable timing information (represented by t4 in enlarged portion of representation 450) that is earlier than the timestamp or any other suitable timing information generated by first photodetector array 114 (represented by t3 in enlarged portion of representation 450).

Referring back to FIG. 3, process 300 can begin, at 310, by receiving timing information that represents an arrival time of a photon at a photodetector from each photodetector in a dual-ended readout detector and from a pair of dual-ended readout detectors energy information indicative of an energy of the photon detected at a photodetector from each photodetector in a dual-ended readout detector and from a pair of dual-ended readout detectors. An illustrative example of the timing information and the energy information is shown in FIG. 4. For example, in detector A of FIG. 4 (e.g., one of the pair of time-of-flight dual-ended readout detector blocks 110 in detector assembly 100) which includes first photodetector array 114 and second photodetector array 116 positioned on opposing ends of scintillator array 112, process 300 can use data acquisition circuitry to receive first timing information and first energy information from first photodetector array 114 and second timing information and second energy information from second photodetector array 116 in response to a gamma photon 402 being detected within scintillator array 112 of detector A. In continuing this example, in detector B of FIG. 4 (e.g., the opposing detector in the pair of time-of-flight dual-ended readout detector blocks 110 in detector assembly 100) which includes first photodetector array 114 and second photodetector array 116 positioned on opposing ends of scintillator array 112, process 300 can also use data acquisition circuitry to receive third timing information and third energy information from first photodetector array 114 and fourth timing information and fourth energy information from second photodetector array 116 in response to a gamma photon 402 being detected within scintillator array 112 of detector B.

In some embodiments, process 300 can obtain the timing information, the energy information, and/or any other suitable data associated with coincidence events based on a target energy window. For example, in using a positron emission tomography system having detector assembly 100 that includes a pair of time-of-flight dual-ended readout detector blocks 110, each detector in detector assembly 100 can assign an energy signal or any other suitable energy information and a timestamp or any other suitable timing information to each detected gamma photon. In continuing this example, a target energy window can be applied to select energies within a range surrounding 511 keV, such as about 400 keV to about 650 keV, for selecting coincidence events and the timing information, the energy information, and/or any other suitable data associated with such coincidence events can then be obtained, where each coincident pair can define a line-of-response connecting two dual-ended readout detector blocks 110 in the positron emission tomography system that detected the gamma photons.

Process 300 can, at 320, determine timing information for each dual-ended readout detector in a pair of dual-ended readout detectors (e.g., the above-mentioned detector A and detector B). For example, the timing information for each dual-ended readout detector can be determined by averaging the timing information generated by first photodetector array 114 and second photodetector array 116 positioned on opposing ends of scintillator array 112. For a pair of dual-ended readout detectors (e.g., detector A and detector B in FIG. 4), this can be represented by:

$${t}_{A} = ( {t}_{1} + {t}_{2} ) / 2$$

$${t}_{B} = ( {t}_{3} + {t}_{4} ) / 2$$

where tᵢ (i=1 . . . 4) represents the threshold crossing time generated by the four photodetectors (e.g., each first photodetector array 114 and second photodetector array 116) of the two detectors (e.g., each dual-ended readout detector block 110 in a pair of dual-ended detectors), t_{A} represents the timing information for detector A (e.g., one of dual-ended readout detector block 110), and t_{B} represents the timing information for detector B (e.g., the opposing dual-ended readout detector block 110).

Process 300 can, at 330, determine the timing difference of coincident photons detected by the pair of dual-ended readout detectors that correspond to a coincidence event based on the determined timing information. For example, the timing difference of two coincident gamma photons from a positron decay detected by the two time-of-flight dual-ended readout detector blocks can be represented by:

$$Δ t = {t}_{A} - {t}_{B} = \frac{( {t}_{1} + {t}_{2} - {t}_{3} - {t}_{4} )}{2}$$

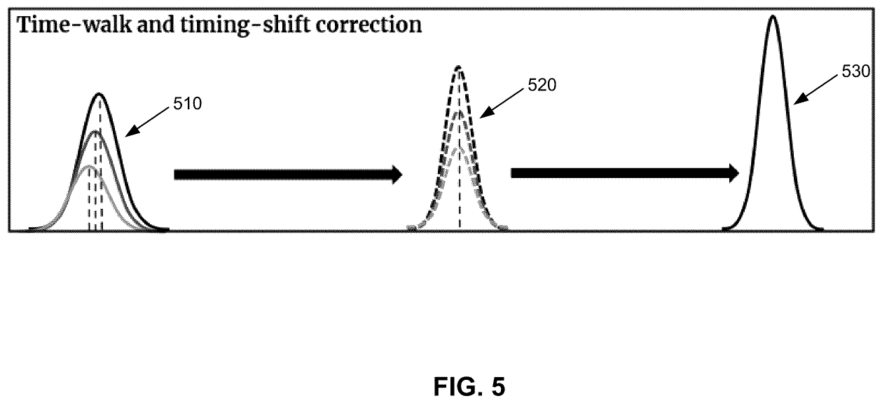

In some embodiments, at 340, process 300 can generate a corrected timing difference that can include a time-walk time correction and/or a timing-shift time correction. As shown in representation 450 of FIG. 4, the threshold crossing times tᵢ (i=1 . . . 4) suffer from both time-walk and timing-shift and, as such, the timing difference, Δt, is also influenced by both time-walk and timing-shift. For example, as shown in FIG. 5, an illustrative example of uncorrected timing signals that include time-walk and timing-shift is shown in a representation 510. As described hereinbelow, the time-walk time correction and the timing-shift time correction can be determined based on the energies detected by the photodetectors of each dual-ended readout detector block 110. For example, as also shown in FIG. 5, an illustrative example of corrected timing signals that include the time-walk time correction and the timing-shift time correction is shown in a representation 520 and an illustrative example of a timing signal that combines the corrected timing signals of coincidence events within an energy window is shown in a representation 530.

For a pair of events arriving simultaneously at the fronts ends of two time-of-flight dual-ended readout detector blocks 110, if the same threshold (Vₜₕ) is applied to both detector blocks 110, the difference in threshold crossing time can be represented as (T₁−T₂), which can also represent the time-walk. In terms of the energy signals detected by the fronts ends of two time-of-flight dual-ended readout detector blocks 110 (E_{d1} and E_{d2}), the difference in threshold crossing time, (T₁−T₂), can be represented as:

$${T}_{1} - {T}_{2} = cln ( {E}_{d 1} / {E}_{d 2} )$$

where c is a constant value.

Accordingly, for detector assembly 100 that includes two time-of-flight dual-ended readout detector blocks 110, the timing difference in threshold crossing time can be represented as:

$$\{ \begin{matrix}{t}_{1} - {t}_{4} = {c}_{14} ln ( \frac{{E}_{1}}{{E}_{4}} ) + {b}_{14} \\ {t}_{2} - {t}_{3} = {c}_{23} ln ( \frac{{E}_{2}}{{E}_{3}} ) + {b}_{23}\end{matrix}$$

$$or$$

$$\{ \begin{matrix}{t}_{1} - {t}_{3} = {c}_{13} ln ( \frac{{E}_{1}}{{E}_{3}} ) + {b}_{13} \\ {t}_{2} - {t}_{4} = {c}_{24} ln ( \frac{{E}_{2}}{{E}_{4}} ) + {b}_{24}\end{matrix}$$

where

$${c}_{14} ln ( \frac{{E}_{1}}{{E}_{4}} ) ,$$

$${c}_{23} ln ( \frac{{E}_{2}}{{E}_{3}} ) ,$$

$${c}_{13} ln ( \frac{{E}_{1}}{{E}_{3}} ) ,$$

$$and$$

$${c}_{24} ln ( \frac{{E}_{2}}{{E}_{4}} )$$

can be used for time-walk time correction and b₁₄, b₂₃, b₁₃, and b₂₄ can be used for timing-shift time correction.

It should be noted that b₁₄, b₂₃, b₁₃, and b₂₄ are different for events with different depth-of-interaction information.

Using the above-mentioned representation for the timing difference of two gamma photons from a positron decay detected by the two detectors and the above-mentioned representation for the timing difference of threshold crossing time in a dual-ended readout detector, the corrected time difference or Δt_{corrected} can be represented as:

$$Δ {t}_{c orrected} = Δ t - \frac{1}{2} ( {c}_{23} ln ( \frac{{E}_{2}}{{E}_{3}} ) + {b}_{23} ) - \frac{1}{2} ( {c}_{14} ln ( \frac{{E}_{1}}{{E}_{4}} ) + {b}_{14} )$$

$$or$$

$$Δ {t}_{c orrected} = Δ t - \frac{1}{2} ( {c}_{13} ln ( \frac{{E}_{1}}{{E}_{3}} ) + {b}_{13} ) - \frac{1}{2} ( {c}_{24} ln ( \frac{{E}_{2}}{{E}_{4}} ) + {b}_{24} ) .$$

It should be noted that, as the timing-shift is different for events with different depth-of-interaction information, process 300 can, in some embodiments, categorize events into different layers based on the depth-of-interaction information. This can be done, for example, by using the ratio of the two energies detected by first photodetector array 114 and second photodetector array 116 coupled to each end of scintillator array 112 in each detector block 110. For example, if a crystal or crystal array is divided into N depth-of-interaction layers, the two crystals in coincidence include N² layer pairs. In a more particular example, as shown in representation 450 of FIG. 4, each scintillator array 112 in detector block 110 can be divided into four depth-of-interaction layers and, as there are two detector block 110 in detector assembly 100, the two scintillator arrays 112 in coincidence can include 16 layer pairs. As shown in representation 450, based on the ratio of the two signal amplitudes of the energy signals in detector A (e.g., E₁/E₂) and based on the ratio of the two signal amplitudes of the energy signals in detector B (e.g., E₃/E₄), the interaction location of the gamma photon 402 can be determined to be within a layer 460 of the four layers in scintillator array 112 of detector A and the interaction location of the gamma photon 412 can be determined to be within a layer 465 of the four layers in scintillator array 112 of detector B.

It should be noted that the crystal positioned between two photodetectors (e.g., scintillatory array 112 between first photodetector array 114 and second photodetector array 116) can be divided into any suitable number of depth-of-interaction layers (e.g., including one).

Turning to FIG. 6, an illustrative example 600 of a process for determining the number of depth-of-interaction layers for dividing a crystal positioned between dual-ended detectors is shown in accordance with some embodiments of the disclosed subject matter. In some embodiments, blocks of process 600 can be performed on any suitable device, such as computing device 170, a server, or any other suitable device. In some embodiments, blocks of process 600 can be performed using multiple devices.

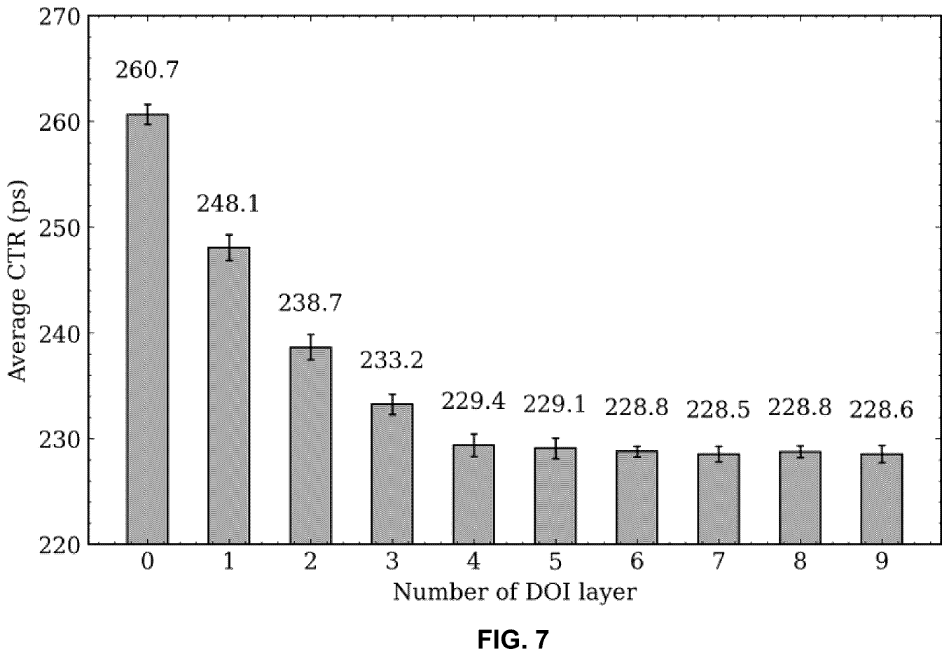

Process 600 can begin at 610 by determining the coincidence timing resolution for a positron emission tomography system having two time-of-flight dual-ended readout detector blocks in which there are no depth-of-interaction layers in the crystal pairs. It should be noted that having no depth-of-interaction layers in the crystal pairs indicates that the time-walk and timing-shift corrections described in the above-mentioned process are not performed. For example, as shown in FIG. 7, the average coincidence timing resolution across four central crystal pairs in a positron emission tomography system having two time-of-flight dual-ended readout detector blocks in which there are no depth-of-interaction layers in the crystal pairs, was determined to be about 260.7 picoseconds.

In some embodiments, process 600 can, at 620, increment the number of depth-of-interaction layers (e.g., by adding an additional depth-of-interaction layer) and determine the coincidence timing resolution for a positron emission tomography system having two time-of-flight dual-ended readout detector blocks in which there is one depth-of-interaction layer. It should be noted that having one depth-of-interaction layer indicates that the time-walk correction in the above-mentioned process has been performed on the timing information from the positron emission tomography system having two time-of-flight dual-ended readout detector blocks, but that the timing-shift correction in the above-mentioned process has not been performed on the timing information from the positron emission tomography system having two time-of-flight dual-ended readout detector blocks. For example, as shown in FIG. 7, the average coincidence timing resolution across four central crystal pairs in a positron emission tomography system having two time-of-flight dual-ended readout detector blocks and having one depth-of-interaction layer, was determined to be about 248.1 picoseconds.

Process 600 can determine whether the coincidence timing resolution for a positron emission tomography system having two time-of-flight dual-ended readout detector blocks in which there is an additional depth-of-interaction layer has improved or otherwise been enhanced by at least a threshold value (e.g., one picosecond) at 630. For example, as shown in FIG. 7, the average coincidence timing resolution across four central crystal pairs in a positron emission tomography system having two time-of-flight dual-ended readout detector blocks, improved from 260.7 picoseconds to 248.1 picoseconds in response to having one depth-of-interaction layer such that a time-walk correction can be performed on the timing information.

It should be noted that the threshold value can be any suitable value. For example, the threshold value can be one picosecond. In another example, the threshold value can be a percentage increase from the previous coincidence timing resolution for the positron emission tomography system, such as at least a one percent increase in coincidence timing resolution. In yet another example, process 600 can identify whether the updated coincidence timing resolution for the positron emission tomography system having the additional depth-of-interaction layer is considered statistically significant from the previous coincidence timing resolution.

In response to determining that the coincidence timing resolution for the positron emission tomography system has improved, process 600 can set the current number of depth-of-interaction layers to one at 640 (e.g., number of DOI layers=1).

In some embodiments, process 600 can, at 650, continue to increment the number of depth-of-interaction layers and determine the coincidence timing resolution for the positron emission tomography system having the additional depth-of-interaction layer (e.g., two depth-of-interaction layers in crystal pairs) until it has been determined that the coincidence timing resolution for the positron emission tomography system has not improved or otherwise been enhanced by at least the threshold value. For example, as shown in FIG. 7, process 600 can determine that the average coincidence timing resolution across four central crystal pairs in the positron emission tomography system having five depth-of-interaction layers in the crystal pairs (e.g., 229.1 picoseconds) and compare the updated coincidence timing resolution against the average coincidence timing resolution across four central crystal pairs in the positron emission tomography system having four depth-of-interaction layers in the crystal pairs (e.g., 229.4 picoseconds). In continuing this example, process 600 can determine that the improvement from 229.4 picoseconds to 229.1 picoseconds is not greater than a threshold value (e.g., 1 picosecond).

In response, process 600 can then set the number of depth-of-interaction layers in the crystal pairs. For example, as shown in FIG. 7, process 600 can set the number of depth-of-interaction layers in the crystal pairs to four layers.

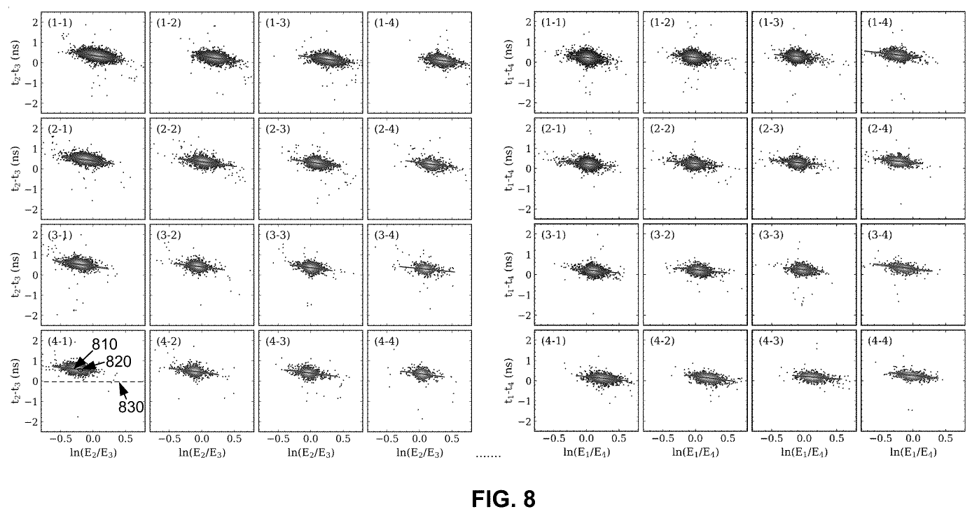

Referring back to FIGS. 3 and 4, the events detected by the crystals in each dual-ended readout detector blocks 110 can be categorized into different depth-of-interaction layers (e.g., four layers as shown in FIG. 4) upon the application of an energy window (e.g., 400-650 keV) to select particular events. The timing information and energy information of these events can be obtained using data acquisition circuitry that is connected to the pair of dual-ended readout detector blocks 110. Turning to FIG. 8, illustrative scatter plots of the threshold crossing time difference (e.g., t₂−t₃ and t₁−t₄ in nanoseconds) on a vertical axis versus the natural logarithm of the energy ratio (e.g., ln

$$( \frac{{E}_{2}}{{E}_{3}} )$$

and ln

$$( \frac{{E}_{1}}{{E}_{4}} ) )$$

on a horizontal axis is shown for one crystal pair and for particular depth-of-interaction layer pairs. As shown by a fitting line 810 in the scatter plot for depth-of-interaction layer pair (4-1), the slope of the fitting line can indicate the presence of time-walk. As also shown in FIG. 8, the displacement of a center point 820 from zero nanoseconds (which is indicated by a line 830) can indicate the presence of timing-shift.

It should be noted that, while FIG. 8 shows illustrative scatter plots of the threshold crossing time difference against the natural logarithm of the energy ratio for one crystal pair, the scatter plots in FIG. 8 can be generated for every crystal pair in the positron emission tomography system. Alternatively, in some embodiments, a subset of crystal pairs can be selected for detecting coincidence events and, in turn, for obtaining timing information and energy information for generating the scatter plots in FIG. 8 or otherwise determining the slope of the fitting lines and the displacement of a center point from zero. For example, due to the use of point source 130 that is centrally located between two dual-ended readout detector blocks 110, crystal pairs

$${C}_{i}^{A} {C}_{65 - i}^{B}$$

are capable of detecting coincidence events, where i=1 . . . 64 and where

$${C}_{i}^{A}$$

$$and$$

$${C}_{65 - i}^{B}$$

denote the order of the crystals in detector A and detector B, respectively. In continuing this example, the central four crystals of each crystal array (e.g., scintillator array 112) can be selected for detecting coincidence events—e.g.,

$${C}_{27}^{A} {C}_{38}^{B} ,$$

$${C}_{28}^{A} {C}_{37}^{B} ,$$

$${C}_{37}^{A} {C}_{28}^{B} ,$$

$$and$$

$${C}_{38}^{A} {C}_{27}^{B} .$$

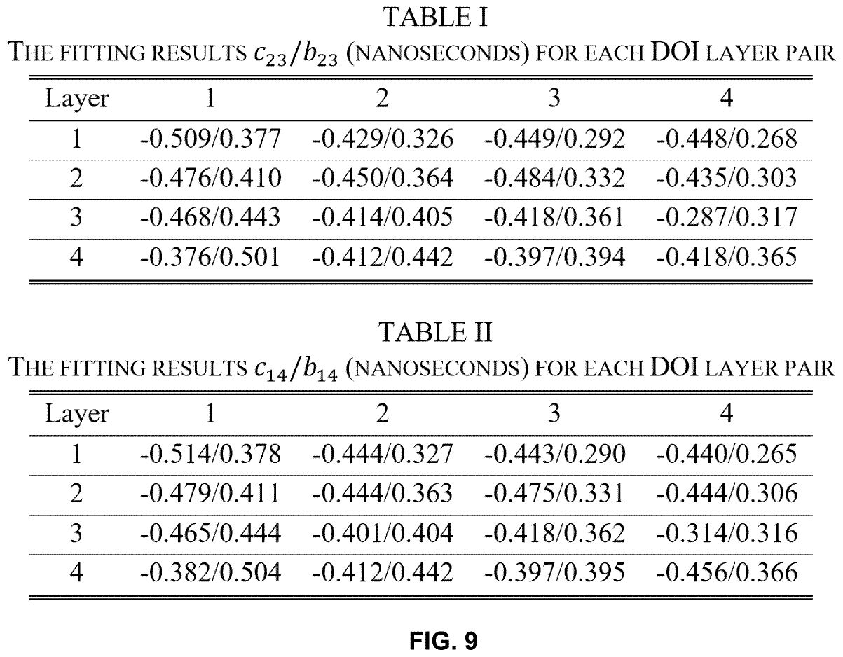

In some embodiments, the time-walk time correction can be determined by determining the slope (e.g., c₂₃ and c₁₄) of the fitting line in each scatter plot representing a depth-of-interaction layer pair. As shown in the table of FIG. 9, the slope or fitting results for c₂₃ and c₁₄ are shown for sixteen depth-of-interaction layer pairs.

In some embodiments, the timing-shift time correction can be determined by determining the displacement (e.g., b₂₃ and b₁₄) from zero nanoseconds in each scatter plot representing a depth-of-interaction layer pair. As shown in the table of FIG. 9, the displacement or fitting results for b₂₃ and b₁₄ are shown for sixteen depth-of-interaction layer pairs. It should be noted that FIG. 9 indicates that a greater layer difference corresponds to a larger timing-shift (and, therefore, a greater timing-shift time correction) and the existence of the timing offset among the different channels of the readout circuitry.

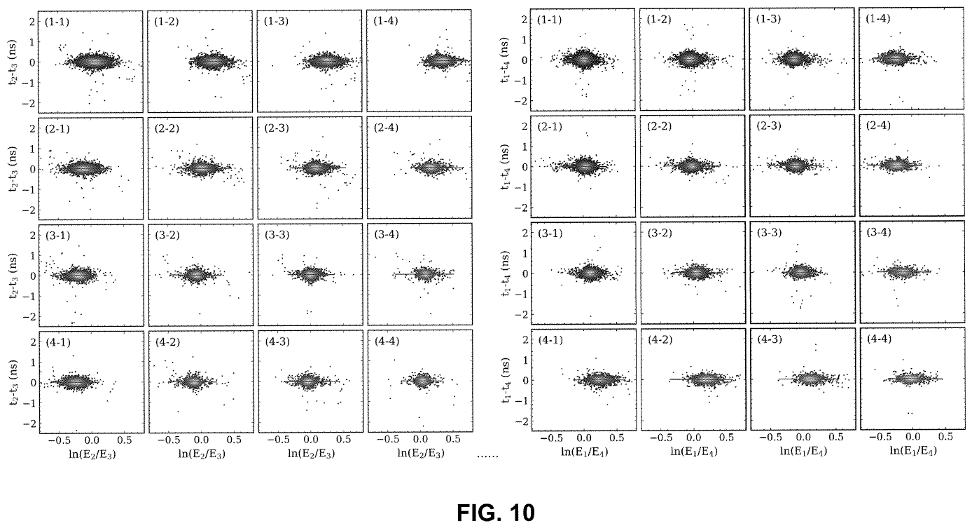

In response to determining the timing-shift time correction and the time-walk time correction based on the detected energy signals for each of the depth-of-interaction layer pairs, a corrected timing signal can be generated in which the determined timing-shift time correction and the determined time-walk time correction can be applied. For example, as shown in FIG. 10, an illustrative scatter plot of the threshold crossing time difference (e.g., t₂−t₃ and t₁−t₄ in nanoseconds) on a vertical axis versus the natural logarithm of the energy ratio (e.g., ln

$$( \frac{{E}_{2}}{{E}_{3}} )$$

and ln

$$( \frac{{E}_{1}}{{E}_{4}} ) )$$

on a horizontal axis is shown for one crystal pair and for particular depth-of-interaction layer pairs in which the determined timing-shift time correction and the determined time-walk time correction have been applied. As shown by a fitting line 1010 in the scatter plot for depth-of-interaction layer pair (4-1), the slope of the fitting line no longer indicates the presence of time-walk as the time-walk has been corrected.

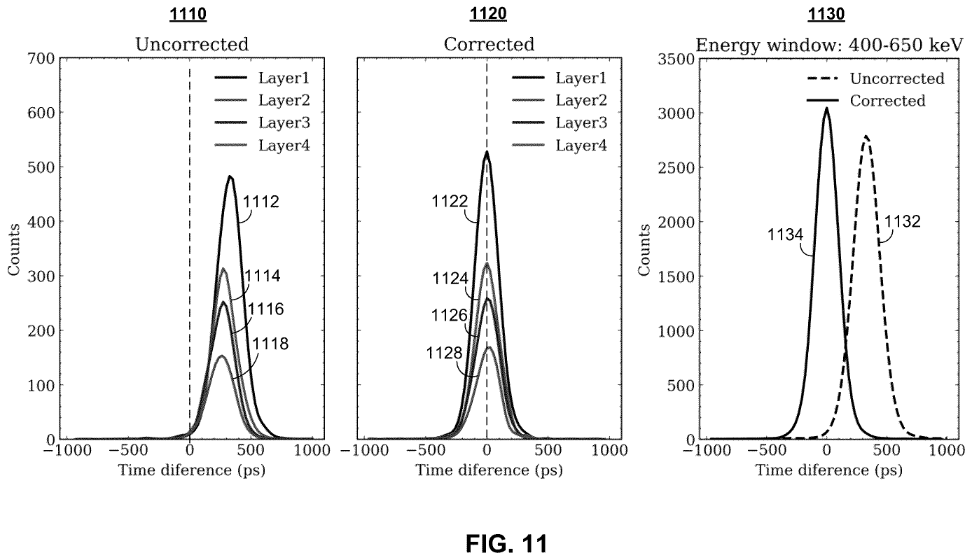

In addition to the scatter plots in FIG. 8 including uncorrected timing information and the scatter plots in FIG. 10 including modified timing information that includes the timing-shift time correction and the time-walk time correction for multiple depth-of-interaction layer pairs, FIG. 11 shows an illustrative example of timing spectra of one crystal pair (e.g., the same crystal pair analyzed in FIGS. 8 and 10) in accordance with some embodiments of the disclosed subject matter.

For example, as shown in a representation 1110 of FIG. 11, representation 1110 includes timing spectra for coincidence events from each of the four depth-of-interaction layers—e.g. a first depth-of-interaction layer represented by timing spectra 1112, a second depth-of-interaction layer represented by timing spectra 1114, a third depth-of-interaction layer represented by timing spectra 1116, and a fourth depth-of-interaction layer represented by timing spectra 1118. As also shown in representation 1110 of FIG. 11 in which the timing information has not been corrected for timing-shift or time-walk, the peak positions of the timing spectra for events from different depth-of-interaction layers 1112, 1114, 1116, and 1118 are unaligned. It should be noted that relative peak position differences may be caused by the depth-of-interaction effect and the deviations from zero nanoseconds may be caused by the timing-offset of the readout circuitry used to obtain timing information and energy information from detector blocks 110.

On the other hand, as shown in a representation 1120 of FIG. 11, representation 1120 includes timing spectra for coincidence events from each of the four depth-of-interaction layers—e.g. a first depth-of-interaction layer represented by timing spectra 1122, a second depth-of-interaction layer represented by timing spectra 1124, a third depth-of-interaction layer represented by timing spectra 1126, and a fourth depth-of-interaction layer represented by timing spectra 1128—in which the timing spectra is generated using modified timing information that includes the timing-shift time correction and the time-walk time correction for multiple depth-of-interaction layer pairs. As also shown in representation 1120 of FIG. 11, the peak positions of the timing spectra for events from different depth-of-interaction layers 1122, 1124, 1126, and 1128 are aligned with a time difference of zero picoseconds, which indicates no presence of timing-shift as timing-shift has been corrected and, as such, the coincidence timing resolution has been enhanced. Using the modified timing information to correct the timing-offsets can enhance the localization accuracy of the gamma interaction position along the line-of-response, thereby improving the image quality of images constructed by the positron emission tomography system.

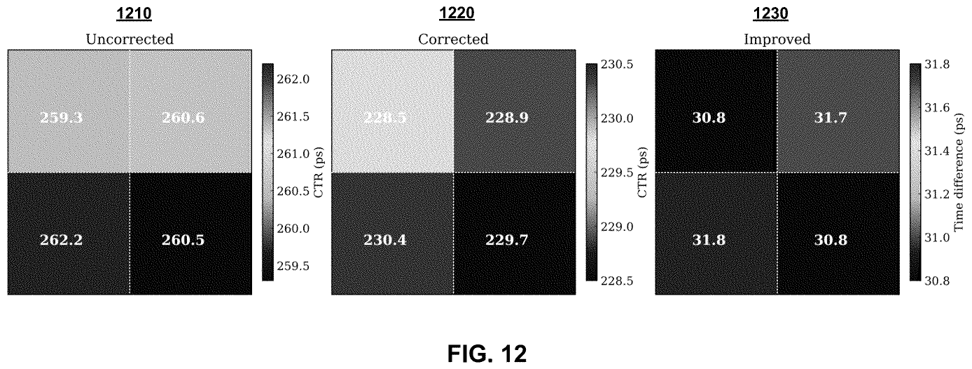

This is also shown, for example, in FIG. 12 in which the coincidence timing resolution is shown for selected crystal pairs from the two dual-ended readout detector blocks 110 in coincidence. As mentioned above, the central four crystals of each crystal array (e.g., scintillator array 112) can be selected for detecting coincidence events—e.g.,

$${C}_{27}^{A} {C}_{38}^{B} ,$$

$${C}_{28}^{A} {C}_{37}^{B} ,$$

$${C}_{37}^{A} {C}_{28}^{B} ,$$

$$and$$

$${C}_{38}^{A} {C}_{27}^{B} .$$

As shown in a representation 1210 that illustrates coincidence timing resolution for crystal pairs in which the above-mentioned timing corrections for timing-shift and time-walk have not been performed, representation 1210 indicates that the uncorrected coincidence timing resolution exhibited poorer coincidence timing resolution values. In response to generating modified timing information in which time-walk time corrections and timing-shift time corrections were applied, a representation 1220 indicates that the average coincidence timing resolution across the four crystal pairs improved to 229.4±1.0 picoseconds from 260.7±1.0 picoseconds when, in this illustrative example, using an energy window of about 400 keV to 650 keV for event selection. The improvement in coincidence timing resolution across the four crystal pairs is also shown in a representation 1230. In addition to improved coincidence timing resolution, representation 1220 indicates a more uniform distribution of coincidence timing resolution across the four crystal pairs.

Referring back to FIG. 3, upon generating a corrected timing information that includes a time-walk timing correction and/or a timing-shift time correction at 340, the corrected timing information can be used for generating an image of an object at 350.

In some embodiments, at least some of the above described blocks of the processes of FIGS. 3 and 6 can be executed or performed in any order or sequence not limited to the order and sequence shown in and described in connection with the figures. Also, some of the above blocks of FIGS. 3 and 6 can be executed or performed substantially simultaneously where appropriate or in parallel to reduce latency and processing times. Additionally or alternatively, some of the above described blocks of the processes of FIGS. 3 and 6 can be omitted.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, positron emission tomography systems having dual-ended readout detectors and methods for enhancing timing resolution are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A positron emission tomography system comprising:
a first dual-ended readout detector and a second dual-ended readout detector, wherein a point source is positioned between the first dual ended readout detector and the second dual-ended readout detector, wherein each of the first dual-ended readout detector and the second dual-ended readout detector comprise: a scintillation crystal, a first photodetector coupled to an end of the scintillation crystal, and a second photodetector coupled to an opposing end of the scintillation crystal, and wherein the first dual-ended readout detector and the second dual-ended readout detector are configured to detect a coincidence event pair resulting from the annihilation of positrons from the point source; and
a processor connected to the first dual-ended readout detector and the second dual-ended readout detector, wherein the processor is configured to enhance timing resolution of the positron emission tomography system by:
receiving, from the first dual-ended readout detector and the second dual-ended readout detector, timing information corresponding to an arrival time of a photon at each of the first photodetector and the second photodetector and energy signal information indicative of an energy of the photon at each of the first photodetector and the second photodetector; and
generating corrected timing information for association with each energy signal received from the first dual-ended readout detector and the second dual-ended readout detector by modifying the timing information based on the energy signal information and a time difference between the timing information from each of the first dual-ended readout detector and the second dual-ended readout detector.

2. The positron emission tomography system of claim 1, wherein the scintillation crystal in each of the first dual-ended readout detector and the second dual-ended readout detector is a scintillation crystal array having a plurality of scintillation crystal elements.

3. The positron emission tomography system of claim 2, wherein each of the plurality of scintillation crystal elements in the scintillation crystal array is composed of one of: a lutetium-yttrium oxyorthosilicate (LYSO) crystal element, a bismuth germanate (BGO) crystal element, a gadolinium aluminum gallium garnet (GAGG) crystal element, and a lutetium oxyorthosilicate (LSO) crystal element.

4. The positron emission tomography system of claim 2, wherein the scintillation crystal array includes an inter-crystal reflector.

5. The positron emission tomography system of claim 4, wherein the inter-crystal reflector in the scintillation crystal array is composed of barium sulfate.

6. The positron emission tomography system of claim 2, wherein each of the first photodetector and the second photodetector is a photodetector array having a plurality of photodetector elements.

7. The positron emission tomography system of claim 6, wherein each of the plurality of photodetector elements in the photodetector array corresponds to a scintillation crystal element in the scintillation crystal array.

8. The positron emission tomography system of claim 6, wherein a coupling material is placed between the scintillation crystal and each of the first photodetector and the second photodetector.

9. The positron emission tomography system of claim 6, wherein each of the plurality of photodetector elements in the photodetector array is a silicon photomultiplier.

10. The positron emission tomography system of claim 1, wherein the processor is further configured to determine the timing information for each of the first dual-ended readout detector and the second dual-ended readout detector based on first timing information received by the first photodetector and second timing information received by the second photodetector.

11. The positron emission tomography system of claim 1, wherein the processor is further configured to determine the timing information for each of the first dual-ended readout detector and the second dual-ended readout detector by averaging first timing information received by the first photodetector and second timing information received by the second photodetector.

12. The positron emission tomography system of claim 1, wherein the processor is connected to a first acquisition circuit and a second acquisition circuit, wherein the first acquisition circuit is configured to obtain the timing information and the energy signal from the first photodetector and the second photodetector of the first dual-ended readout detector, and wherein the second acquisition circuit is configured to obtain the timing information and the energy signal from the first photodetector and the second photodetector of the second dual-ended readout detector.

13. The positron emission tomography system of claim 1, wherein the processor is further configured to divide the scintillation crystal in the first dual-ended readout detector and the second dual-ended readout detector into a plurality of depth-of-interaction layers, wherein the timing information and the energy signal information is associated with one of the plurality of depth-of-interaction layers based on a ratio of a first signal amplitude of the energy signal information detected by the first photodetector and a second signal amplitude of the energy signal information detected by the second photodetector, and wherein timing resolution including the corrected timing information is determined for pairs of the plurality of depth-of-interaction layers in the first dual-ended readout detector and the second dual-ended readout detector.

14. The positron emission tomography system of claim 13, wherein the processor is further configured to modify the timing information in each of the plurality of depth-of-interaction layers based on a logarithmic relationship between the ratio of the first signal amplitude of the energy signal information detected by the first photodetector and the second signal amplitude of the energy signal information detected by the second photodetector and timing difference information based on first timing information corresponding to the arrival time of the photon at the first photodetector and second timing information corresponding to the arrival time of the photon at the second photodetector.

15. A method for generating enhanced images using a positron emission tomography system, the method comprising:
receiving, from a processor connected to a first dual-ended readout detector and a second dual-ended readout detector, wherein a point source is positioned between the first dual ended readout detector and the second dual-ended readout detector, wherein each of the first dual-ended readout detector and the second dual-ended readout detector comprise: a scintillation crystal, a first photodetector coupled to an end of the scintillation crystal, and a second photodetector coupled to an opposing end of the scintillation crystal, and wherein the first dual-ended readout detector and the second dual-ended readout detector are configured to detect a coincidence event pair resulting from the annihilation of positrons from the point source, timing information corresponding to an arrival time of a photon at each of the first photodetector and the second photodetector and energy signal information indicative of an energy of the photon at each of the first photodetector and the second photodetector;
generating corrected timing information for association with each energy signal received from the first dual-ended readout detector and the second dual-ended readout detector by modifying the timing information based on the energy signal information and a time difference between the timing information from each of the first dual-ended readout detector and the second dual-ended readout detector; and
generating an image of an object using the corrected timing information.

16. The method of claim 15, wherein the method further comprises determining the timing information for each of the first dual-ended readout detector and the second dual-ended readout detector based on first timing information received by the first photodetector and second timing information received by the second photodetector.

17. The method of claim 15, wherein the method further comprises determining the timing information for each of the first dual-ended readout detector and the second dual-ended readout detector by averaging first timing information received by the first photodetector and second timing information received by the second photodetector.

18. The method of claim 15, wherein the method further comprises using a first acquisition circuit to obtain the timing information and the energy signal from the first photodetector and the second photodetector of the first dual-ended readout detector and using a second acquisition circuit to obtain the timing information and the energy signal from the first photodetector and the second photodetector of the second dual-ended readout detector.

19. The method of claim 15, wherein the method further comprises dividing the scintillation crystal in the first dual-ended readout detector and the second dual-ended readout detector into a plurality of depth-of-interaction layers, wherein the timing information and the energy signal information is associated with one of the plurality of depth-of-interaction layers based on a ratio of a first signal amplitude of the energy signal information detected by the first photodetector and a second signal amplitude of the energy signal information detected by the second photodetector, and wherein timing resolution including the corrected timing information is determined for pairs of the plurality of depth-of-interaction layers in the first dual-ended readout detector and the second dual-ended readout detector.

20. The method of claim 19, wherein the method further comprises modifying the timing information in each of the plurality of depth-of-interaction layers based on a logarithmic relationship between the ratio of the first signal amplitude of the energy signal information detected by the first photodetector and the second signal amplitude of the energy signal information detected by the second photodetector and timing difference information based on first timing information corresponding to the arrival time of the photon at the first photodetector and second timing information corresponding to the arrival time of the photon at the second photodetector.

21. A non-transitory computer-readable medium containing computer executable instructions that, when executed by a processor, cause the processor to perform a method for generating enhanced images using a positron emission tomography system, the method comprising:
receiving, from a processor connected to a first dual-ended readout detector and a second dual-ended readout detector, wherein a point source is positioned between the first dual ended readout detector and the second dual-ended readout detector, wherein each of the first dual-ended readout detector and the second dual-ended readout detector comprise: a scintillation crystal, a first photodetector coupled to an end of the scintillation crystal, and a second photodetector coupled to an opposing end of the scintillation crystal, and wherein the first dual-ended readout detector and the second dual-ended readout detector are configured to detect a coincidence event pair resulting from the annihilation of positrons from the point source, timing information corresponding to an arrival time of a photon at each of the first photodetector and the second photodetector and energy signal information indicative of an energy of the photon at each of the first photodetector and the second photodetector;
generating corrected timing information for association with each energy signal received from the first dual-ended readout detector and the second dual-ended readout detector by modifying the timing information based on the energy signal information and a time difference between the timing information from each of the first dual-ended readout detector and the second dual-ended readout detector; and
generating an image of an object using the corrected timing information.
